(19) United States
(12) Patent Application Publication
(10) Pub. No.: US 2007/0242448 A1
(43) Pub. Date: Oct. 18, 2007

(54) ELECTRO LUMINESCENT LIGHT SOURCE WITH BACKING

(75) Inventors: Michael Sangyup Lee, Baltimore, MD (US); Rafael Lodewijk Vanreusel, Reisterstown, MD (US)

Correspondence Address: H.C. PARK & ASSOCIATES, PLC, 8500 LEESBURG PIKE, SUITE 7500, VIENNA, VA, 22182, US

(73) Assignee: PTC International, Inc., Baltimore, VA (US)

(21) Appl. No.: 11/279,701

(22) Filed: Apr. 13, 2006

(51) Int. Cl. F21V 9/16

(52) U.S. Cl. 362/84

(57) ABSTRACT

A light emitting display unit includes an electroluminescent display device and a control unit supplying power to, and controlling light emission of, the electroluminescent display device. The control unit includes a controller, a power supply, and conductor. The electroluminescent display device and the control unit may be formed as single, integrated unit, or they may be detachably coupled with each other.

### BACKGROUND OF THE INVENTION

1. Field of the Invention

The present invention relates to a light emitting unit, and more particularly, to an electroluminescent display device, a controller, and a power supply that may be formed as a single, mountable, integrated unit.

2. Discussion of the Background

Generally, light sources that use electroluminescence to emit light are becoming increasingly popular because of their numerous benefits, including they do not generate a lot of heat, they may be made flat, flexible and durable, and they do not consume a lot of power. As FIG. 14 shows, a conventional electroluminescent (EL) device may include an EL plate 1, a controller 2 for controlling the EL plate's lighting pattern, and wiring 3 connecting the EL plate 1 with the controller 2.

However, in such a device, the exposed wiring 3 connecting the EL plate 1 to the controller 2 may be fragile, and the EL plate 1 may eventually bend or break since it may not adequately support itself. Further, the controller 2 and power supply are separated from the EL plate 1. This arrangement may cause problems in utilizing such a device because it may be unsightly to hang, operationally ineffective or potentially dangerous due to exposed wiring.

### SUMMARY OF THE INVENTION

The present invention provides a light emitting display unit that may be formed as an integrated unit, as well as a light emitting display unit having an EL display device that may be detachably coupled with a control unit.

Additional features of the invention will be set forth in the description which follows, and in part will be apparent from the description, or may be learned by practice of the invention.

The present invention discloses a light emitting display unit including an electroluminescent device, a controller to control light emission of the electroluminescent device, a power supply to supply power to the electroluminescent device, and a conductor that couples the controller with the electroluminescent device. The electroluminescent device, the controller, the power supply, and the conductor compromise a single, integrated unit.

The present invention also discloses a light emitting display unit including an electroluminescent device and control unit supplying power to, and controlling light emission of, the electroluminescent device. The electroluminescent device is detachably coupled with the control unit.

The present invention also discloses a light emitting display unit including an electroluminescent plate, a backing coupled with the electroluminescent plate and having a first coupler, a cover having a second coupler, and a control unit. The control unit includes a power supply, a terminal to couple with an external power supply, and a controller to control light emission of the electroluminescent plate. The first coupler and the second coupler detachably couple the backing and the cover, and the control unit is arranged within the cover.

It is to be understood that both the foregoing general description and the following detailed description are exemplary and explanatory and they are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIGS. 1A and 1B show a light emitting display unit according to an exemplary embodiment of the present invention.

FIG. 2A, FIG. 2B, FIG. 2C show the light emitting display unit of FIG. 1A and FIG. 1B.

FIG. 3A and FIG. 3B show a light emitting display unit according to an exemplary embodiment of the present invention.

FIG. 4A and FIG. 4B are photographs of a light emitting display unit according to an exemplary embodiment of the present invention.

FIG. 5A and FIG. 5B are rear and front views, respectively, of the light emitting display unit of FIG. 4A, and FIG. 5C and FIG. 5D are rear and front views, respectively, of the light emitting display unit of FIG. 4B.

FIG. 6A, FIG. 6B, and FIG. 6C are photographs of the light emitting display units of FIG. 4A and FIG. 4B.

FIG. 7A is a top/bottom view of the light emitting display units of FIG. 4A and FIG. 4B, and FIG. 7B and FIG. 7C are side views of the light emitting display units of FIG. 4A and FIG. 4B.

FIGS. 8 and 9 are exploded perspective views showing a light emitting display unit according to an exemplary embodiment of the present invention.

FIG. 10 and FIG. 11 show the light emitting display unit conductor units for the controller and the backing according to an exemplary embodiment of the present invention.

FIG. 12 is a close-up view of a cover of a light emitting display unit according to an exemplary embodiment of the present invention.

FIG. 13 is a close-up view of a backing of a light emitting display unit according to an exemplary embodiment of the present invention.

FIG. 14 shows a conventional light emitting display unit.

### DETAILED DESCRIPTION OF THE ILLUSTRATED EMBODIMENTS

In the following detailed description, only certain exemplary embodiments of the present invention have been shown and described, simply by way of illustration. As those skilled in the art would realize, the described embodiments may be modified in various ways, all without departing from the spirit or scope of the present invention. Accordingly, the drawings and description are to be regarded as illustrative and not restrictive. Like reference numerals designate like elements throughout the specification.

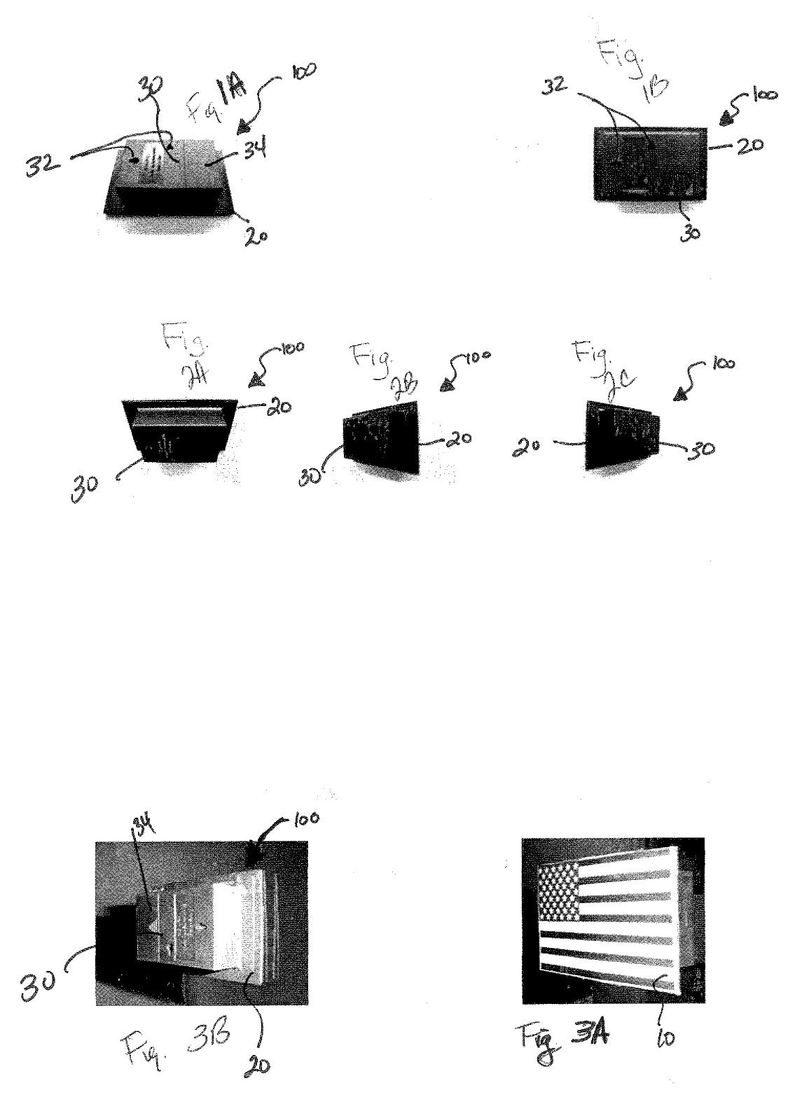

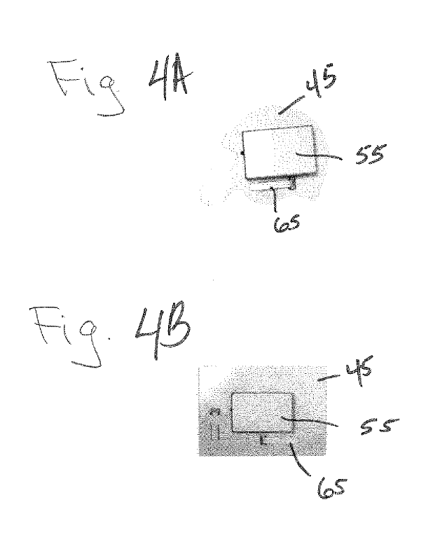

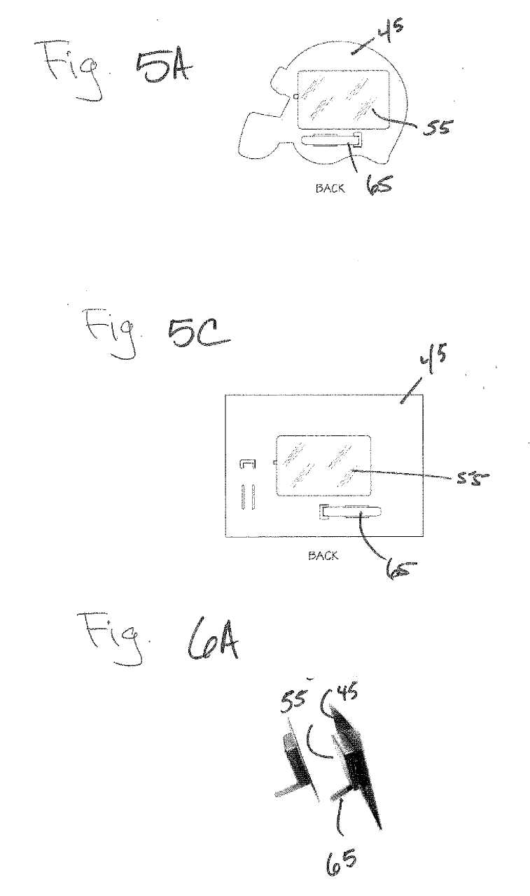

FIG. 1A, FIG. 1B, FIG. 2A, FIG. 2B, FIG. 2C, FIG. 3A, and FIG. 3B show a light emitting display unit according to an exemplary embodiment of the present invention. Referring to FIG. 1A through FIG. 3B, the light emitting display unit may include an electroluminescent (EL) device 10, a controller (not shown), a power supply (not shown) and a conductor (not shown) arranged as a single, integrated unit.

The light emitting display unit includes an integrated backing unit 100, which may be made of a plastic mold, iron, cast, metal, aluminum or any other similar materials. The integrated backing unit 100 includes a backing 20 and a cover 30. The EL device 10 is coupled with the front side of the backing 20, and the cover 30 protrudes from the rear side of the backing 20. For example, the EL device 10 may be coupled with the front side of the backing 20 with an adhesive. As shown in FIG. 1A through FIG. 3B, the cover 30 and the backing 20 are integrally formed (i.e. they are formed together as a single piece). The controller, the power supply, and the conductor are arranged in the cover 30.

The EL device 10 emits visible light. The EL device 10 may be an EL plate, which generally includes a thin, flexible substrate that may emit monochrome light or multi-colored lights such as red, green and blue light. An EL plate includes luminescent pieces that illuminate when a current is run through it. These luminescent pieces can be cut into any shape, configuration or design. An image(s) (usually created by a type of screenprinting or other art decoration) is layered onto a thin film, which is layered over the luminescent pieces. A controller triggers certain parts of the luminescent strips to light up, thus image(s) on the front can light up all at once or in different sequences. This image(s) is considered to be part of the light up EL display device 10.

The controller controls the EL device's light emission pattern, and it is coupled with the EL device 10 via a conductor. The controller is a series of various electrical components that allow for control of the EL device's light emissions. The sequence of light emission patterns can vary from one sequence to a multitude depending on the size of the controller. The larger the controller, the more sequences can be added—thus the more light emission patterns. The controller 40 and the EL device 10 may be electrically coupled together via conductors, such as wiring, metallic plates (similar to battery exchanges in rechargeable batteries), springs (as used in normal alkaline battery exchange) or similar types of electrical transfer.

The light emitting display unit includes a power supply for supplying power to operate the EL device 10. The power supply is arranged within the cover 30. For example, the power supply may comprise a battery or batteries, which may be inserted into the cover 30 at a portion under a battery covering 34. The battery or batteries may be non-rechargeable or rechargeable, and no specific battery type is required. Rather, the battery or batteries need only supply an appropriate amount of power to the EL device 10. The controller may also include a terminal that may be coupled with an external power supply, so that the light emitting display unit is capable of being powered using an external power.

The light emitting display unit may have various forms. The backing 20 may be substantially the same size and shape as the EL device 10. While the backing 20 and EL device 10 are shown in exemplary embodiments of the present invention as having a football helmet (FIG. 5A and FIG. 5B) or rectangular shape, they may have any shape, including circular, elliptical, or polygonal. Furthermore, the cover 30 may have substantially the same shape as the backing 20 and the EL device 10. However, the cover 30 may be smaller than the backing 20 so that the edges of the backing 20 are exposed.

The light emitting display unit may be coupled with a surface, such as glass or a wall, as shown in FIG. 3A and FIG. 3B. A fastener may be included on the display side (i.e. front side) of the EL device 10, as well as the rear side of the cover 30. The fastener on the rear side of the cover 30 permits the light emitting display unit to be coupled with a surface, such as a wall. As FIG. 1B shows, the fastener on the rear side of the cover 30 may be a hole 32 for hanging the unit on the wall. Additionally, the fastener on the display side of the display unit permits the light emitting display unit to be coupled with a surface, such as glass. For example, a first mounting strip may be attached to the EL device 10 so that the light emitting unit may be coupled with a second, corresponding mounting strip on a surface, such as a window. Other fasteners may be used, particularly those that are capable of detachably coupling the light emitting display unit with a surface, like suction cups, string or wire attached to suction cups. Fasteners arranged on the display side of the EL device 10 may be substantially transparent so that they block as little of the light emitted as possible.

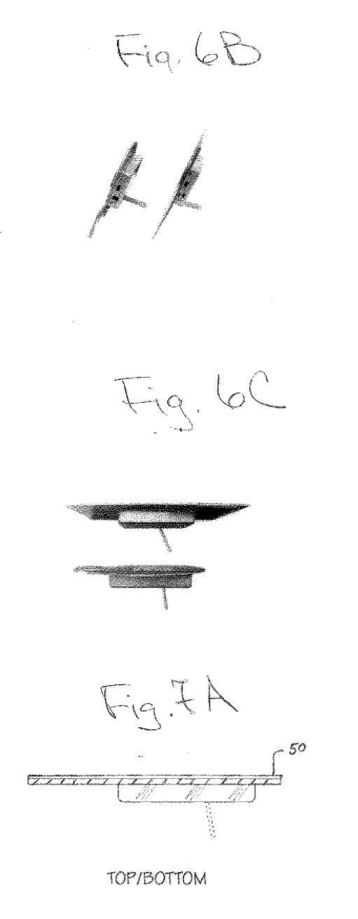

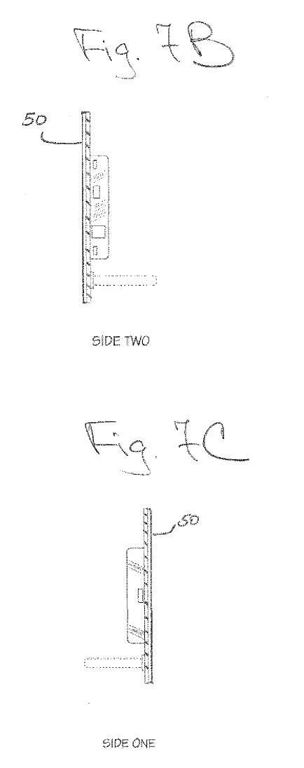

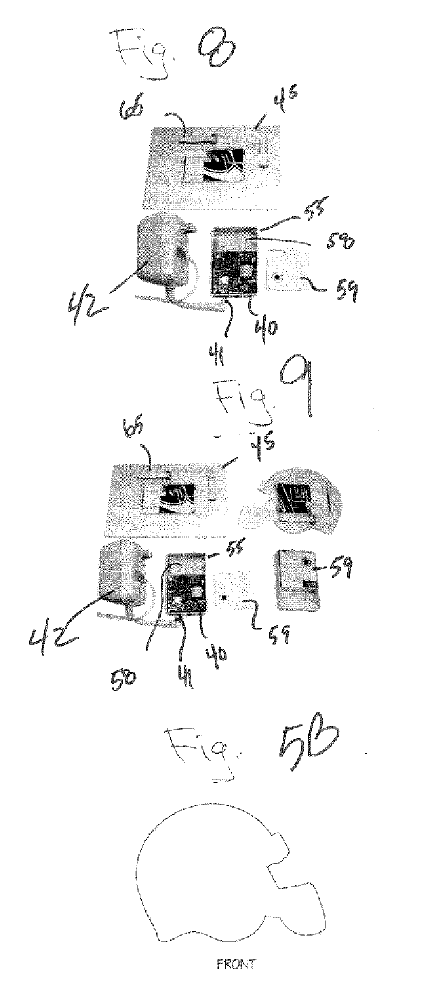

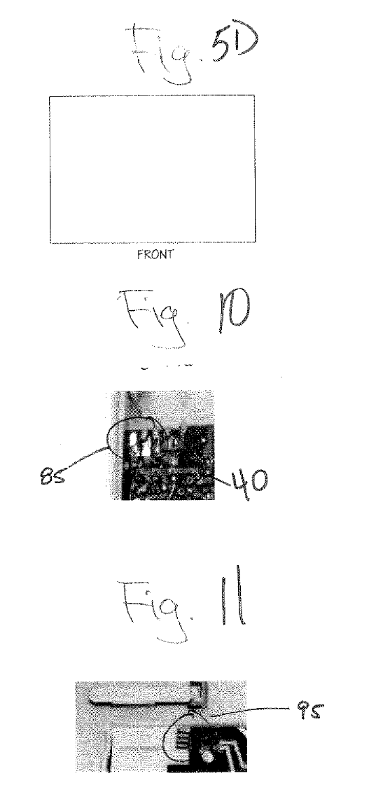

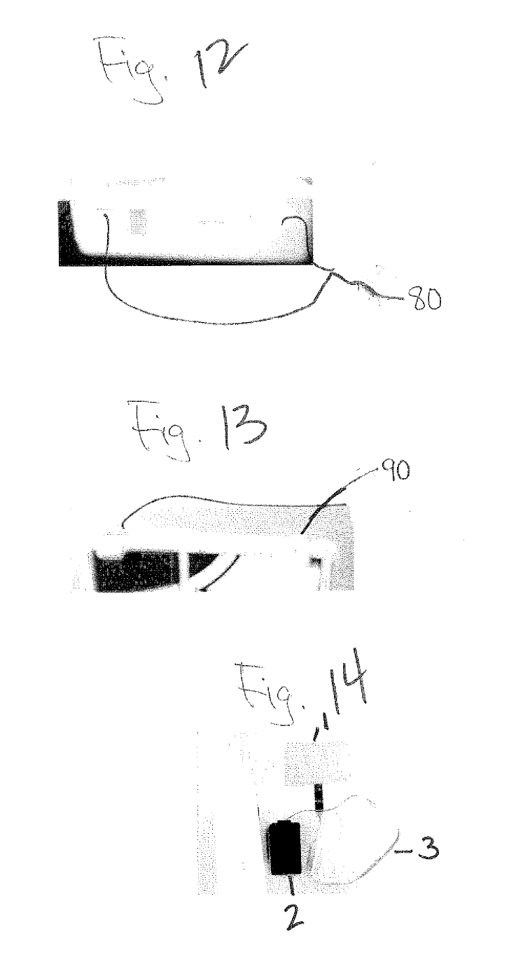

FIG. 4A, FIG. 4B, FIG. 5A, FIG. 5B, FIG. 5C, FIG. 5D, FIG. 6A, FIG. 6B, FIG. 6C, FIG. 7A, FIG. 7B, FIG. 7C, FIG. 8, FIG. 9, FIG. 10, FIG. 11, FIG. 12, and FIG. 13 show a light emitting display unit according to other exemplary embodiments of the present invention.

A light emitting display unit according to another exemplary embodiment of the present invention is similar to the light emitting display unit described above. However, the light emitting display unit described below includes an EL device and a control unit, and the EL device is detachably coupled with the control unit. The EL device emits light, and the control unit supplies power to, and controls the light emission of, the EL device. Such an arrangement permits multiple EL devices, each of which may display a different image or message, to be individually coupled with a single control unit. Hence, while each EL device may be securely fastened together with the control unit, it may also be easily and quickly removed and replaced with a different EL device without damaging either the device or the control unit.

Referring to FIG. 4A through FIG. 13, the controller 40 and the EL device are arranged on opposite sides of a backing 45, and they are electrically coupled through a hole in the backing 45. The EL device may be an EL plate 50, and the EL plate 50 is coupled with the front side of the backing 45. The controller 40 includes electrical circuits to control light emission of the EL plate 50, and a power supply, such as a battery, may be arranged in a power supply area 58 of a cover 55. Hence, the controller 40 and the power supply may be arranged in the cover 55. The controller 40 may sit on a tray 59 to position the controller 40 within the cover 55 and establish a secure electrical connection between the controller 40 and the EL plate 50. Furthermore, the tray 59 may also help secure the controller 40 in place when the cover 55 is on.

The rear side of the backing 45 may be detachably coupled with the cover 55 using a clip and lock system as is commonly used in cell phone battery attachments. As shown in FIG. 13, the rear side of the backing 45 may have a small ‘male’ piece or bump out 90 that would fit into the ‘female’ slot or hole 80 of the cover 55, as shown in FIG. 12. As FIGS. 7B and 7C show, two sides of the cover 55 may be equipped with ‘female’ slots or holes 80 into which ‘male’ pieces or bump outs 90 of the backing 45 may be inserted.

Various methods may be used to detachably couple the cover 55 and controller 40 with the EL plate 50. For example, the backing 45 may include protrusions to be arranged in indentations of the cover 55. Alternatively, Velcro could be used to detachably couple the backing 45 and the cover 55. Furthermore, the controller 40 and the EL plate 50 could be electrically and mechanically coupled together at a single point.

The controller 40 and the EL plate 50 may have conductors including wiring, metallic plates (similar to battery exchanges in rechargeable batteries), or springs (as used in normal alkaline battery exchange) for the transfer of electrical signals between the controller 40 and the EL plate 50. For example, as FIG. 10 and FIG. 11 show, wirings 85 from the controller 40 may be electrically coupled with wirings 95 of the EL plate when the unit is assembled.

The controller 40 may also include a terminal 41 that may be coupled with an external power supply 42, so that the light emitting display unit is capable of being powered using an external power.

An arm 65 may be arranged on the backing 45 or on the cover 55 to prop the display unit on a horizontal surface, such as a shelf.

As described above, a light emitting display unit may be formed as an integrated unit to provide a safer, more reliable EL display unit. Furthermore, a light emitting display unit may be formed with a control unit that may be detachably coupled with various EL devices without damaging the EL devices or the control unit. Such a configuration provides great flexibility to a user since the user may display multiple messages with a single control unit by easily interchanging the EL device.

It will be apparent to those skilled in the art of various modifications and variation can be made in the present invention without departing from the spirit and scope of the invention. Thus, it is intended that the present invention cover the modifications and variations of this invention provided that they come within the scope of the appended claims and their equivalents.

What is claimed is:

1. A light emitting display unit, comprising:
an electroluminescent device;
a controller to control light emission of the electroluminescent device;
a power supply to supply power to the electroluminescent device; and
a conductor that couples the controller with the electroluminescent device,
wherein the electroluminescent device, the controller, the power supply and the conductor comprise a single, integrated unit.

2. The light emitting display unit of claim 1, further compromising:
an integrated backing unit comprising a backing and a cover that are integrally formed together,
wherein the electroluminescent device is coupled with a first side of the backing, the cover is arranged on a second side of the backing, and the controller, the power supply and the conductor are all arranged within the cover.

3. The light emitting display unit of claim 2, wherein the backing is substantially the same size and shape as the electroluminescent device, and the cover is smaller than the backing.

4. The light emitting display unit of claim 3, wherein the integrated backing unit comprises a plastic mold.

5. The light emitting display unit of claim 1, wherein the electroluminescent device comprises an electroluminescent plate.

6. A light emitting display unit, comprising:
an electroluminescent device; and
a control unit to supply power to, and to control light emission of, the electroluminescent device,
wherein the electroluminescent device is detachably coupled with the control unit.

7. The light emitting display unit of claim 6, wherein the electroluminescent device comprises an electroluminescent plate.

8. The light emitting display unit of claim 7, further compromising:
a backing,
wherein the electroluminescent plate is coupled with a first side of the backing, and the backing is detachably coupled with the control unit at a second side of the backing.

9. The light emitting display unit of claim 8, further compromising:
a cover coupled with the second side of the backing,
wherein the control unit is arranged within the cover.

10. The light emitting display unit of claim 9, wherein the second side of the backing comprises a first coupling part, the cover comprises a second coupling part, and the first coupling part and the second coupling part detachably couple the backing with the cover.

11. The light emitting display unit of claim 10, wherein the second side of the backing comprises a third coupling part, and the control unit comprises a fourth coupling part, and the third coupling part and the fourth coupling part electrically couple the electroluminescent plate with the control unit.

12. The light emitting display unit of claim 10, wherein the first coupling part comprises a first locking mechanism, and the second coupling part comprises a second locking mechanism, the first locking mechanism interfacing with the second locking mechanism to couple the backing with the cover.

13. The light emitting display unit of claim 12, wherein the second locking mechanism comprises a cutout in the cover.

14. The light emitting display unit of claim 10, wherein the first coupling part comprises a protrusion, and the second coupling part comprises an indentation, the protrusion being arranged within the indentation to couple the backing with the cover.

15. The light emitting display unit of claim 10, wherein the first coupling part and the second coupling part comprise Velcro.

16. The light emitting display unit of claim 9, wherein the cover comprises a substantially rectangular, square, circular, elliptical, polygonal, or helmet-like shape.

17. The light emitting display unit of claim 16, wherein a surface area of the electroluminescent plate exceeds a surface area of the cover.

18. The light emitting display unit of claim 17, wherein the electroluminescent plate has substantially the same shape as the cover.

19. The light emitting display unit of claim 6, further comprising:
a fastener coupled with a display side of the electroluminescent device,
wherein the fastener couples the light emitting display unit with a surface.

20. The light emitting display unit of claim 19, wherein the light emitting display unit is detachably coupled with the surface.

21. The light emitting display unit of claim 19, wherein the fastener is transparent.

22. The light emitting display unit of claim 10, further comprising:
a fastener on a rear side of the cover,
wherein the fastener couples the light emitting display unit with a surface.

23. The light emitting display unit of claim 22, wherein the fastener comprises a hole in the rear side of the cover.

24. The light emitting display unit of claim 6, wherein the control unit comprises a power supply.

25. The light emitting display unit of claim 24, wherein the power supply is a battery.

26. The light emitting display unit of claim 24, wherein the control unit further comprises a terminal that may be coupled with an external power source to supply power to the electroluminescent device.

27. The light emitting display unit of claim 24, further comprising:
a cover,
wherein the control unit and the power supply are arranged within the cover.

28. The light emitting display unit of claim 9, further comprising a movable arm to prop the light emitting display unit on a horizontal surface.

29. The light emitting display unit of claim 28, wherein the arm is connected to the cover or the second side of the backing.

30. A light emitting display unit, comprising:
an electroluminescent plate;
a backing coupled with the electroluminescent plate and comprising a first coupler;
a cover comprising a second coupler; and
a control unit comprising:
a power supply;
a terminal to couple with an external power supply; and
a controller to control light emission of the electroluminescent plate;
wherein the first coupler and the second coupler detachably couple the backing with the cover, and the control unit is arranged within the cover.

31. The light emitting display unit of claim 30, wherein:
the controller comprises a third coupler;
the first coupler comprises a first coupling part and a second coupling part; and
the first coupling part and the second coupler mechanically couple the backing with the cover, and the second coupling part and the third coupler electrically couple the electroluminescent plate with the controller.
